(19) United States
(12) Patent Application Publication
(10) Pub. No.: US 2010/0258691 A1
(43) Pub. Date: Oct. 14, 2010

(54) DETACHABLE SCREEN PROTECTOR ASSEMBLY FOR LARGE FLAT PANEL DISPLAYS

(76) Inventors: James J. Zdancewicz, Berwyn, PA (US); Dana C. Zdancewicz, Berwyn, PA (US); Andrew R. Richards, Ambler, PA (US); Andrea N. Sweeney-Richards, Ambler, PA (US); Andrew C. Lees, Royersford, PA (US)

Correspondence Address: rudoler & derosa llc;ATTN: DOCKET CLERK, 2 BALA PLAZA,, SUITE 300, BALA CYNWYD, PA, 19004, US

(21) Appl. No.: 12/757,830

(22) Filed: Apr. 9, 2010

Related U.S. Application Data
(60) Provisional application No. 61/212,136, filed on Apr. 9, 2009.

(51) Int. Cl. F16M 13/02; A44B 18/00

(52) U.S. Cl. 248/229.26; 24/306

(57) ABSTRACT

A screen protector assembly for use with a flat panel display having a display panel located on a front surface thereof. The screen protector assembly comprises a transparent screen panel having a pair of slots formed therein adjacent a top edge of the screen panel and a pair of c-shaped hanger clamps for detachably securing the screen panel to the flat panel display. Each clamp hanger comprises a top portion for engaging a top surface of the flat panel display, an arm extending downwardly from the top portion, and a tail portion end for providing a clamping force between the screen panel and the back surface of the front panel display. The arm has a tab protruding rearwardly from the arm with an upwardly extending hook forming a neck for supporting a top surface of the slot. The tab is shaped to fit within the slot of the screen panel such that a top surface of the slot rests on the neck and hangs thereform. A space is formed between a rear surface screen and a front surface of the flat panel display to permit airflow therebetween for ventilation of the display.

### CROSS-REFERENCE TO RELATED APPLICATIONS

100011 The present application claims the benefit of U.S. Provisional Application No. 61/212,136, filed on Apr. 9, 2009, which is incorporated herein by reference.

### STATEMENT REGARDING FEDERALLY SPONSORED RESEARCH OR DEVELOPMENT

The present invention was not developed with the use of any Federal Funds, but was developed independently by the inventor.

### BACKGROUND OF THE INVENTION

1. Technical Field

This invention relates generally to a screen protector device for a flat panel display which is readily and detachably mounted onto a flat panel display in a secure manner and provides improved protection of the front surface of display, improved mounting functionality of the screen protector device relative to the display and improved visual appearance of the protector device when in use.

2. Description of the Related Art

Flat panel displays, especially large flat panel displays, are prone to cracking due to their use of display panels having several layers of glass and polarizing film containing liquid crystals in very close proximity. As the technology behind flat panel displays matures, current generation flat panel displays are decreasing in thickness, increasing their fragility even further. Current large flat display panels are now typically less than two inches thick. The result is that the thin outer glass layer screen of the display panels are increasingly prone too damage. When a display panel is struck hard with an object, it can flex inward and crack, permanently bending or distorting the polarizing film adhered thereto, and thus permanently dislodging the liquid crystals. This then, creates the effect of “cracks” or “spider cracks” in the screen which cannot be repaired without replacing those layers which is prohibitively costly relative to the replacement cost of the flat panel display.

Thus, there exists a need for a screen protector for protecting the display panel and front housing surface, or bezel, of a flat panel display. Further, there is a need for a screen protector that is capable of protecting the fragile flat panel displays from impact damage caused by struck and/or flying objects, such as video game motion controllers, video game controllers, toys, balls, cups, and the like contacting the display; is easily mounted and readily detachable from the flat panel display; is unobtrusive and has an attractive visual appearance when in use; provides protection from fingerprints and dust; and is easily cleaned by the user.

These needs are fulfilled and the shortcomings of the prior art are overcome by the present invention which provides a screen protector assembly which is detachably secured to the front surface of a flat panel display to mitigate or obviate the aforementioned.

### SUMMARY OF THE INVENTION

This invention solves the problems outlined above by providing a screen protector assembly for use with a flat panel display having a display panel located on a front surface thereof. The screen protector assembly comprises a transparent screen panel having a pair of slots formed therein adjacent a top edge of the screen panel and a pair of c-shaped hanger clamps for detachably securing the screen panel to the flat panel display. Each clamp hanger comprises a top portion for engaging a top surface of the flat panel display, an arm extending downwardly from the top portion, and a tail portion end for providing a clamping force between the screen panel and the back surface of the front panel display. The arm has a tab protruding rearwardly from the arm with an upwardly extending hook forming a neck for supporting a top surface of the slot. The tab is shaped to fit within the slot of the screen panel such that a top surface of the slot rests on the neck and hangs thereform. A space is formed between a rear surface of the screen panel and a front surface of the flat panel display to permit airflow therebetween for ventilation of the display.

In one form of the invention, the hanger clamp is fabricated from a polypropylene material and the screen panel is fabricated from is an acrylic glass material.

The screen panel is preferably frameless and is slightly larger than the display panel of the flat panel display whereby providing an unobtrusive and visually attractive appearance to the viewer and to minimize visual distractions of the viewer of the flat panel display.

A hook and loop fastener may be provided for securing a bottom of the screen panel to the flat panel display.

The foregoing and other objects, features, and advantages of the invention become more apparent upon reading the following detailed description with reference to the illustrative drawings.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a front isometric view of the screen protector assembly of the present invention shown in use with flat panel displays;

FIG. 2 is a partial enlarged side view of the screen protector assembly of FIG. 1 shown in use on the display;

FIG. 3 is a partial back isometric view of the screen protector assembly of FIG. 1;

FIG. 4 is a partial enlarged front isometric view of a corner of the screen of the screen protector assembly of FIG. 1;

FIG. 5 is a side view of the bracket of the screen protector assembly of FIG. 1; and

FIG. 6 is a side view of an alternate form of the bracket of the screen protector assembly of FIG. 1.

### DETAILED DESCRIPTION OF THE INVENTION

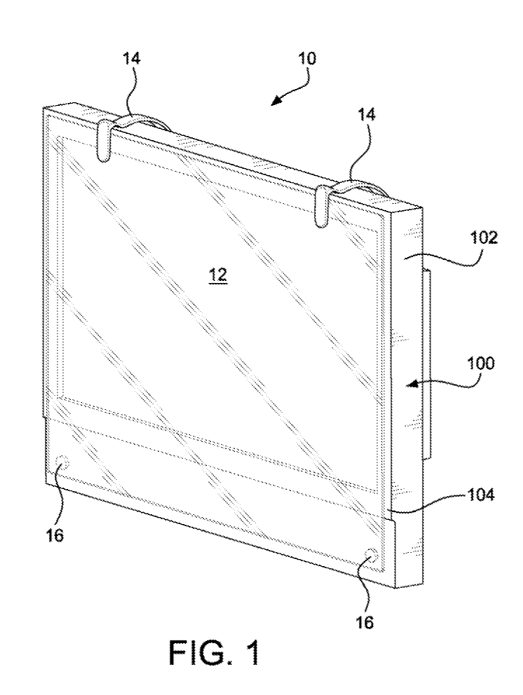

With particular reference to the drawings, the present invention is directed to an improved screen protector assembly 10 for use with a flat panel display 100, especially large flat panel displays having a diagonal screen size over 80 centimeters (31.5 inches). As best seen in FIG. 1, flat panel displays typically comprise a front display panel mounted within a housing cabinet 102 which forms a bezel 104 around the perimeter of the display panel. The display panels of existing flat panel displays are typically fabricated from fragile components and are prone to damage when struck with objects or otherwise contacted with sufficient force. For example, LCD displays are typically fabricated from several layers of glass and polarizing film containing liquid crystals in very close proximity which shatter easily when struck or contacted.

The screen protector assembly 10 of the present invention is suitable for use with all flat panel displays 100, such as plasma displays, liquid crystal displays (LCDs), organic light-emitting diode displays (OLEDs), light-emitting diode displays (LEDs), electroluminescent displays (ELDs), surface-conduction electron-emitter displays (SEDs), field emission displays (FEDs) (also called Nano-emissive displays (NEDs)), rear projection displays, and the like.

FIG. 1 illustrates the screen protector assembly 10 mounted on a flat panel display 100. The screen protector assembly 10 comprises a protective structural screen panel 12, preferably a pair of hanger clamps 14 for mounting the screen panel 12 to the display housing 102, and optionally a fastener 16 for securing the bottom portion of the screen panel 12 to the display housing 102. The hanger clamps 14 secure the screen panel 12 such that it covers the front surface of the display housing 102, overlaying the front display panel of the display 100 and preferably the front of the display's bezel 104 as well to present an attractive, unobtrusive visual appearance that is not distracting to the user's viewing of the images presented on the display.

The screen panel 12 is preferably fabricated from a clear or transparent material that is light-weight and shatter- and scratch-resistant, dust resistant, and fingerprint resistant. Some preferred materials for the protective screen panel 12 of the present invention are clear Poly(methyl methacrylate) (PMMA) or acrylic glass, such as LUCITE® or PLEXIGLASS®, and clear polycarbonate resin thermoplastics, such as LEXAN®. Other transparent shatter and scratch-resistant materials similar to the ones indicated above are also suitable for use with and contemplated by the present invention. The screen panel 12 is most preferably fabricated from a clear acrylic glass material having a thickness of about 0.0125 inches which strikes a good balance between weight and strength, and minimizes optical distortion effects.

The present invention also contemplates providing the screen panel 12 with an anti-reflective film or coating that blocks UV rays and allows users to see the display clearer. In addition, in one preferred embodiment of the present invention, the screen panel 12 is contemplated to have a frameless design that has substantially the same the same dimensions as the front surface 104 of the flat panel display housing 102 so as to provide an unobtrusive and visually attractive appearance to the viewer and to minimize visual distractions of the viewer of the flat panel display. Of course, it should be understood that other designs fall within the scope of the present invention such as providing decorative indicia and/or ornamentation on the screen panel 12 and/or hanger clamps 14 that does not interfere with the viewing of the display panel and/or sizing of the screen panel 12 which is typically slightly larger than the display panel but smaller than or the same size as the display housing 104.

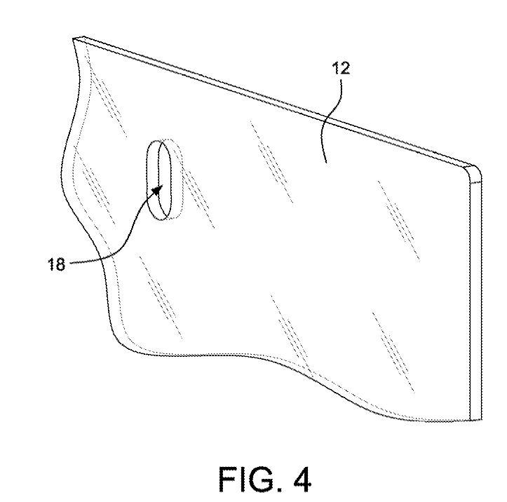

As best seen in FIGS. 1-4, the screen panel 12 comprises a pair of elongated slots 18 formed near the upper edge of the panel 12 for receiving the hanger clamps 14 as explained in greater detail below. Preferably, the slots 18 have rounded top and bottom surfaces as best seen in FIG. 4.

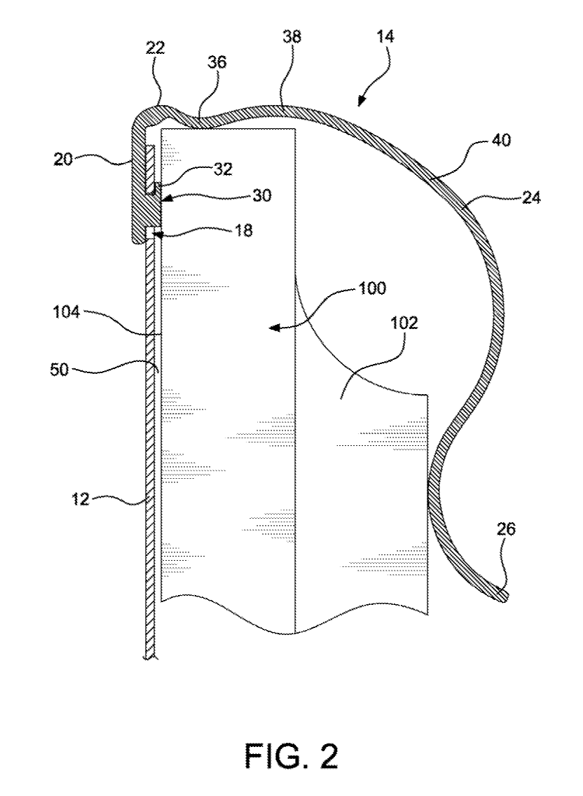

Referring now to FIGS. 1, 2, 3, and 5, the hanger clamps 14 will now be described. The hanger clamp 14 is designed to hang the screen panel 12 from the top surface of the display housing 102 while providing a clamping force to the rear surface of the display housing 102 to fixedly, yet detachably secure the screen panel 12 to the display 100. The hanger clamp 14 comprises a C-shaped body 24 having a downwardly extending arm portion 20 located at one end and a backwardly'curved tail portion 26 disposed at the other end of the body 24. The body portion 24 is curved to flex, thus providing a spring clamping force when the hanger clamp 14 is bent or flexed outwardly such as when the hanger clamp is engaged with the housing 102 of the display monitor 100, as best seen in FIG. 2.

As best seen in FIG. 2, the bight of body portion 24 expands when the clamp is placed on a typical display housing 102. This expansion of the body portion 24 provides the tail portion 26 with an inward force when it contacts the rear surface of the display housing

Intermediate the arm 20 and the body portion 24 is a top portion 38. The top portion 38 comprises a pair of curved portions 22 and 36. The curved portion 22 is a downwardly turned corner which transitions between the substantially horizontal top portion 38 and the substantially vertical arm 20. The curved portion 36 is upwardly curved and the bight of the curve provides a flat surface which engages with the top surface of the display housing 102 as best seen in FIG. 2.

Similarly, the tail portion 26 provides a surface for engaging the rear surface of the display housing 102 as also best seen in FIG. 2.

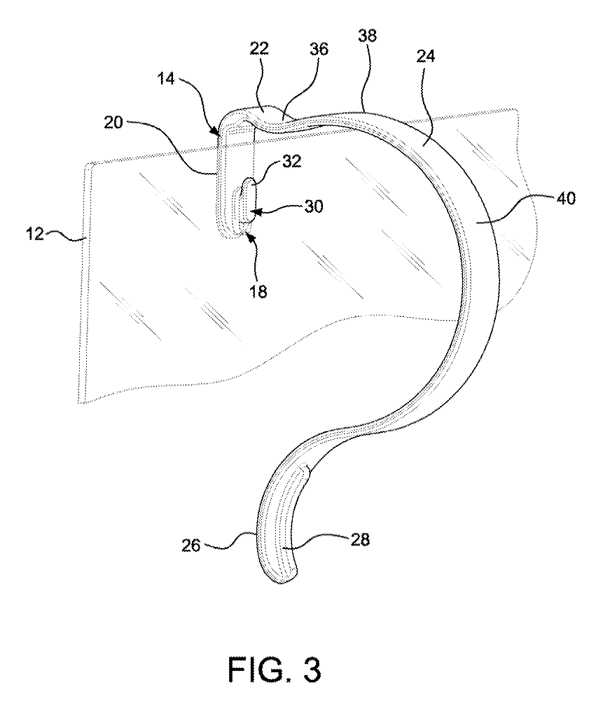

As best seen in FIG. 3, The tail portion 26 preferably has a rib 28 formed thereon for increasing the strength of the tail portion where the clamping force of the hanger clamp 14 is largely localized.

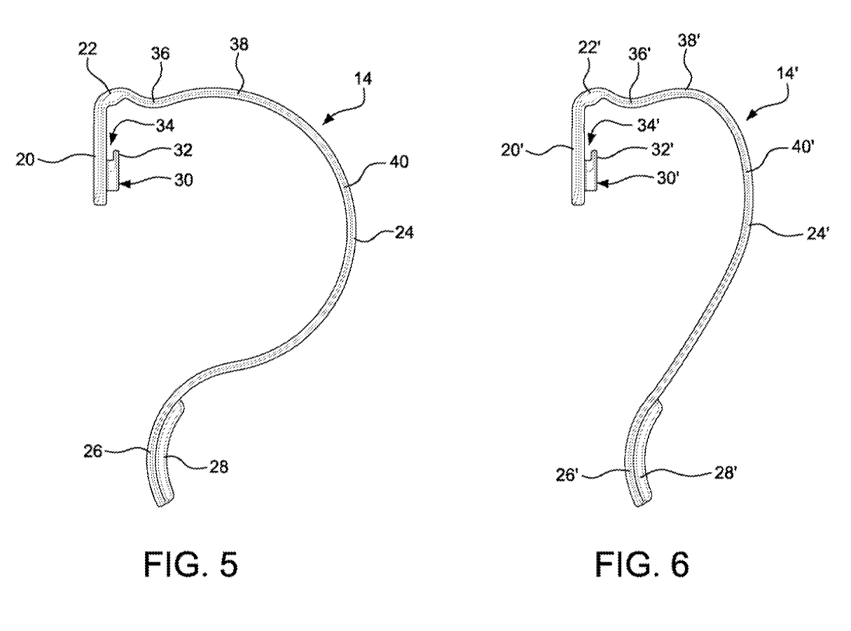

Referring now to FIGS. 2, 3, and 5, extending rearwardly from the arm 20 is a protruding tab or button 30. The tab 30 has an upwardly extending lip 32 forming an upwardly extending hook. The hook forms a neck portion 34 between the back surface of the arm 20 and the front surface of the hook 32. The tab 30 has a shape that is complementary to the elongated slot 18 formed in the panel screen 12 such that the tab 30 fits within the slot 18. As best seen in FIG. 2, the thickness of the neck 34 is slightly larger than thickness of the screen panel 12 such that the screen panel 12 can seat on the top surface of the neck 34 (FIG. 5) and is locked in place thereon when so seated.

Referring again to FIG. 2, it can be clearly seen that the when the hanger clamp 14 is engaged with the display housing 102, the rear surface of the tab 30 contacts the front surface 104 of the display housing 102 while the tail portion 26 engages the rear surface of the display housing 102, providing a frictional clamping force therebetween. In addition the rounded corner portion 36 rests on the top surface of the display housing 102 with the arm 20 of the clamp hanger 14 extending over the top of the display housing 102 and across the front surface 104 of the display housing 102, as best seen in FIGS. 1 and 2.

The clamp hangers 14 are preferably fabricated from a resilient plastic material, such as polypropylene or polycarbonate or other similar material. Most preferably, the clamp hanger 14 is fabricated from 30% Glass Fiber Reinforced, Chemically Coupled, Polypropylene, such as Black GC30P100-01 Polypropylene manufactured by Rhetech.

Referring to FIGS. 2 and 3, the screen panel 12 is shown being supported by the clamp hanger 14. The tab 30 fits within the slot 18 formed within the panel 12 and the top surface of the slot 18 is seated on the top surface of the neck portion 34 of the tab 30 and is thus secured within the hook by virtue of the gravitational force tending to pull the screen panel 12 downwardly. When the panel 12 rests within the neck 34 of tab 30 and the clamp 12 is engaged with a display housing 102, the rear surface of the screen panel 12 is spaced away from the front surface of display housing 102 by the space designated by reference numeral 50 as best seen in FIG. 2. This permits air to flow in space 50 between the screen panel 12 and the display housing 102 to provide adequate ventilation of the display 100 according to manufactures' recommendations.

Referring back now to FIG. 1, the screen protector assembly 10 may also be provided with suitable fasteners 16, such as hook and loop fasteners, provided adjacent the bottom edge of the screen panel 12 to further secure the screen panel 12 to the front surface 104 of the display housing 102 and to prevent cantilevering of the bottom of the screen panel away from the front surface 104 of the display 100 by users, especially by children. It should be understood that other fasteners, such as adhesive pads and the like, are also suitable for use in the present invention to secure the bottom of the screen panel 12 to the front surface of the display housing 102.

FIG. 6 shows an alternate embodiment of the clamp hanger 14′ where like reference numbers represent like elements. The clamp hanger 14′ is for use with newer flat panel displays 100 which are less thick than existing flat panel displays. The primary difference between the embodiment shown in FIG. 5 and the embodiment shown in FIG. 6 is the narrower and less rounded profile of the body portion 24′ since the body portion 24′ does not need to flex as much as body portion 24 when accommodating the thinner flat panel displays it is intended for use with.

In use, the tab 30 of one of the clamp hangers 14 is inserted into each of the slots 18 of the screen panel 12 such that the slot 18 clears the back of the tab 30. The hanger clamps 14 are then pulled upwardly so that each slot 18 rests on the neck portion 34 of each hanger clamp 14, locking the hanger clamps 14 onto the screen panel 12. Then, the screen panel 12 is centered on the front surface of the display housing 102 so that the screen panel 12 evenly overlays the front surface of the display 100 as shown in FIG. 1. As the screen panel 12 is lowered onto the display 100 the tail portions 26 of the hanger clamps 14 engage the top surface of the display housing 102, forcing the hanger clamps 14 to flex outwardly to accommodate the thickness of the display housing 102 until the position shown in FIG. 2 is reached in which the curved portion 22 of the hanger clamps 14 rest on the top surface of the display housing 102. In this flexed position, the hanger clamps 14 provide a clamping force to the display housing 102 securing the screen panel 12 thereto. The fasteners 16 may then be applied adjacent to the lower edge of the screen panel 12 to the bottom of the front surface of the display housing 102.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1 A screen protector assembly for use with a flat panel display having a display panel located on a front surface thereof, the screen protector assembly comprising:
a transparent screen panel having a slot formed therein adjacent a top edge of the screen panel, and
a hanger clamp for detachably securing the screen panel to the front surface of the flat panel display, the clamp hanger comprising a top portion for engaging a top surface of the flat panel display, an arm extending downwardly from the top portion, and a tail portion end for providing a clamping force between the screen panel and the back surface of the front panel display, the arm having a tab protruding rearwardly from the arm, the tab having an upwardly extending hook forming a neck for supporting the slot a top surface of the slot, the tab being shaped to fit within the slot of the screen panel such that a top surface of the slot rests on the neck and hangs thereform.

2. The screen protector assembly according to claim 1 wherein the screen panel is fabricated from a transparent plastic material that is shatter resistant.

3. The screen protector assembly according to claim 2 wherein the transparent material is an acrylic glass material.

4. The screen protector assembly according to claim 1 wherein the hanger clamp is fabricated from a polypropylene material.

5. The screen protector assembly according to claim 1 wherein the hanger clamp is fabricated from a polypropylene material and the screen panel is fabricated from is an acrylic glass material.

6. The screen protector assembly according to claim 1 wherein the screen panel has a pair of the slots formed therein and further comprising a pair of the hanger clamps.

7. The screen protector assembly according to claim 5 wherein the screen panel has a pair of the slots formed therein and further comprising a pair of the hanger clamps.

8. The screen protector assembly according to claim 1 wherein the hanger clamp has a c-shape.

9. The screen protector assembly according to claim 7 wherein the hanger clamp has a c-shape.

10. The screen protector assembly according to claim 1 further comprising a fastener for removably securing a bottom of the screen panel to the front surface of the flat panel display.

11. The screen protector assembly according to claim 9 further comprising a fastener for removably securing a bottom of the screen panel to the front surface of the flat panel display.

12. The screen protector assembly according to claim 1 wherein the fastener is a hook and loop fastener.

13. The screen protector assembly according to claim 11 wherein the fastener is a hook and loop fastener.

14. The screen protector assembly according to claim 1 wherein a space is formed between a rear surface of the screen panel and the front surface of the flat panel display to permit airflow therebetween for ventilation of the display.

15. The screen protector assembly according to claim 13 wherein the screen panel a space is formed between a rear surface of the screen panel and the front surface of the flat panel display to permit airflow therebetween for ventilation of the display.

16. The screen protector assembly according to claim 1 wherein the screen panel is frameless and is slightly larger than the display panel of the flat panel display whereby providing an unobtrusive and visually attractive appearance to the viewer and to minimize visual distractions of the viewer of the flat panel display.

17. The screen protector assembly according to claim 15 wherein the screen panel is frameless and is slightly larger than the display panel of the flat panel display whereby providing an unobtrusive and visually attractive appearance to the viewer and to minimize visual distractions of the viewer of the flat panel display.
